(19) United States
(12) Patent Application Publication
(10) Pub. No.: US 2019/0293599 A1
(43) Pub. Date: Sep. 26, 2019

(54) ANALYZING APPARATUS

(71) Applicant: KABUSHIKI KAISHA TOSHIBA, Minato-ku (JP)

(72) Inventors: Kaita Imai, Edogawa (JP); Yosuke Akimoto, Yokohama (JP); Shouhei Kousai, Yokohama (JP)

(73) Assignee: KABUSHIKI KAISHA TOSHIBA, Minato-ku (JP)

(21) Appl. No.: 16/126,811

(22) Filed: Sep. 10, 2018

(30) Foreign Application Priority Data
Mar. 20, 2018 (JP) 2018-053019

(51) Int. Cl. G01N 27/447

(52) U.S. Cl. CPC G01N 27/44773; G01N 27/4473; G01N 27/44743; G01N 27/44791

(57) ABSTRACT

According to one embodiment, an analyzing apparatus is disclosed. The analyzing apparatus includes a generation device to generate an electromagnetic force for drawing a particle in a first liquid that is to be supplied onto a substrate, wherein the electromagnetic force draws the particle to the substrate side, and a measurement device to measure an image the first liquid on the substrate. The analyzing apparatus further includes a control device to control the generation device, and a liquid channel structure that includes a first supply channel for supplying a liquid onto the substrate and a first drain channel for draining a liquid on the substrate.

### CROSS-REFERENCE TO RELATED APPLICATIONS

This application is based upon and claims the benefit of priority from Japanese Patent Application No. 2018-053019, filed Mar. 20, 2018, the entire contents of which are incorporated herein by reference.

### FIELD

Embodiments described herein relate generally to an analyzing apparatus for analyzing a particle in a liquid.

### BACKGROUND

As an analyzing apparatus for analyzing particles in a specimen liquid, there is the one including an image sensor. The particles include, for example, a cell labeled with a labeling substance and another type of cell not labeled with the labeling substance. The specimen liquid is supplied onto a sensor surface of the image sensor. Although it is necessary to detect whether desired particles are contained in the specimen liquid and to quickly determine the number of particles, a time (settling time) until the particles naturally arrive at the sensor surface is long and it takes time to complete measurement of the particles with the image sensor.

### BRIEF DESCRIPTION OF THE DRAWINGS

FIG. 1 is a plane view showing a schematic configuration of a fine particle analyzing apparatus according to a first embodiment.

FIG. 2 is a sectional view taken along arrows 2-2 of FIG. 1.

FIG. 3 is a diagram for explaining an example of a magnetic force generation device.

FIG. 4 is a sectional view for explaining an operation of the fine particle analyzing apparatus according to the first embodiment.

FIG. 5 is a sectional view for explaining an operation of the fine particle analyzing apparatus according to the first embodiment.

FIG. 6 is a sectional view for explaining an operation of the fine particle analyzing apparatus according to the first embodiment.

FIG. 7 is a sectional view for explaining an operation of the fine particle analyzing apparatus according to the first embodiment.

FIG. 8 is a plane view showing a schematic configuration of a fine particle analyzing apparatus according to a second embodiment.

FIG. 9 is a plane view showing a schematic configuration of a fine particle analyzing apparatus according to a third embodiment.

FIG. 10 is a sectional view taken along arrows 10-10 of FIG. 9.

FIG. 11 is a sectional view for explaining a method for determining a quantity of a specimen liquid supplied into a cavity region of the fine particle analyzing apparatus according to the second embodiment;

FIG. 12 is a sectional view showing a schematic configuration of a fine particle analyzing apparatus according to a fourth embodiment.

FIG. 13 is a diagram showing how a fine particle having chargeability in the specimen liquid is drawn to an electrode by an electrophoretic force.

FIG. 14 is a sectional view showing a schematic configuration of a fine particle analyzing apparatus according to a fifth embodiment.

FIG. 15 is a diagram showing how a fine particle in the specimen liquid is drawn to a first electrode by a dielectrophoretic force.

FIG. 16 is a sectional view showing a schematic configuration of a variation of the fine particle analyzing apparatus according to the fifth embodiment.

FIG. 17 is a diagram showing how a fine particle in the specimen liquid is drawn to the first electrode by the dielectrophoretic force.

FIG. 18 is a sectional view for explaining a variation of a liquid channel structure of the embodiment.

### DETAILED DESCRIPTION

In general, according to one embodiment, an analyzing apparatus is disclosed. The analyzing apparatus includes a generation device to generate an electromagnetic force for drawing a particle in a first liquid that is to be supplied onto a substrate, wherein the electromagnetic force draws the particle to the substrate side, and a measurement device to measure an image of the first liquid on the substrate. The analyzing apparatus further includes a control device to control the generation device, and a liquid channel structure that includes a first supply channel for supplying a liquid onto the substrate and a first drain channel for draining a liquid on the substrate.

Embodiments will be described hereinafter with reference to the accompanying drawings. The drawings are schematic or conceptual drawings, and dimensions and ratios are not necessarily the same as those in reality. Further, in the drawings, the same reference symbols (including those having different subscripts) denote the same or corresponding parts, and overlapping explanations thereof will be made as necessary. In addition, as used in the description and the appended claims, what is expressed by a singular form shall include the meaning of “more than one”.

### First Embodiment

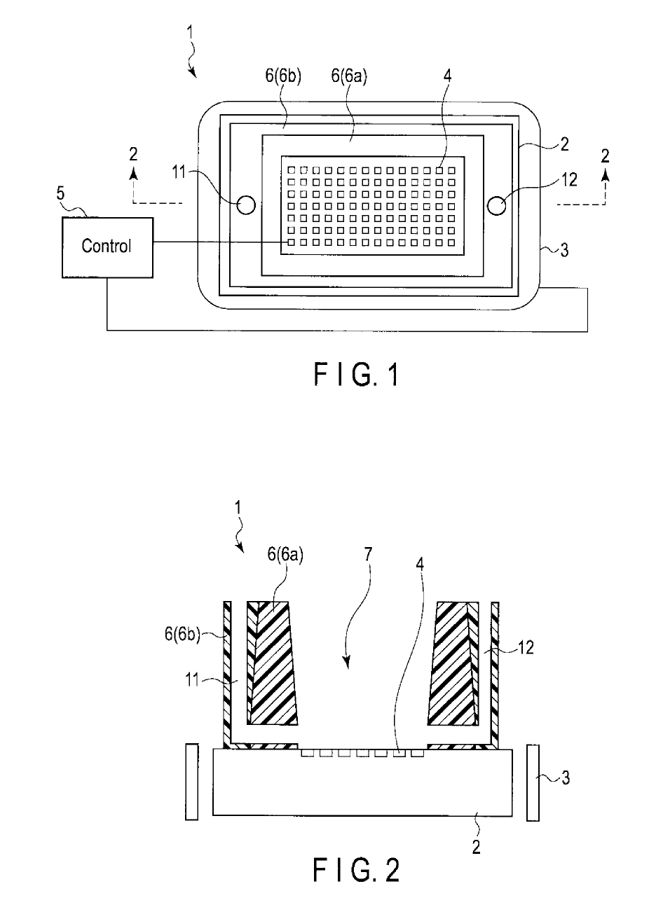

FIG. 1 is a plane view showing a schematic configuration of a fine particle analyzing apparatus 1 according to the first embodiment. FIG. 2 is a sectional view taken along arrows 2-2 of FIG. 1.

The fine particle analyzing apparatus 1 includes a substrate 2. A specimen liquid (liquid) containing fine particles (hereinafter, referred to as a “target particles”), such as cells labeled with a magnetic bead or beads, is supplied onto the substrate 2.

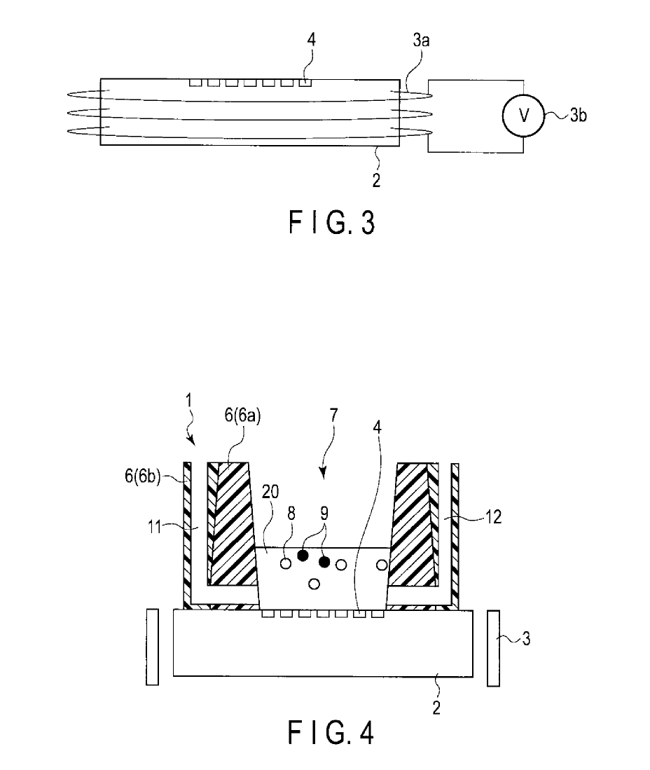

The fine particle analyzing apparatus 1 further includes a magnetic force generation device 3 that generates a magnetic force for drawing the target particle in the specimen liquid on the substrate 2 to the substrate 2 side. The magnetic force generation device 3 is, for example as shown in FIG. 3, an electromagnet that includes a coil 3a disposed so as to surround the substrate 2, and a power source 3b for applying a current to the coil 3a.

The fine particle analyzing apparatus 1 further includes a measurement device 4 that measures an image of the specimen liquid on the substrate 2. In the present embodiment, the measurement device 4 includes an image sensor. The image sensor is, for example, an array sensor, such as a CMOS (complementary metal-oxide semiconductor) image sensor or a CCD (charge coupled device) image sensor. The CMOS image sensor includes photodiodes as photoelectric conversion elements for each pixel and a plurality of MOS transistors that select and drive the photodiodes. In the present embodiment, the measurement device 4 is a lensless image sensor the sensor surface (a plurality of pixels) of which directly contacts the specimen liquid. More specifically, directly contacting the specimen liquid means that an objective lens for magnifying an image to be analyzed is not included between the photodiode and the specimen liquid. The distance between the photodiode and the specimen liquid is less than 1 mm, less than 10 μm, or less than 1 μm. The target particle is drawn and held onto the sensor surface (to the substrate 2 side) by a magnetic force.

The fine particle analyzing apparatus 1 further includes a control device 5 that controls the magnetic force generation device 3. The control device 5 controls the magnetic force generation device 3 so that a magnetic force is generated or the generated magnetic force vanishes. In a case where the magnetic force generation device 3 is an electromagnet shown in FIG. 3, the control device 5 controls on/off of the power source 3b. When the power source 3b is turned on, the coil 3a generates a magnetic force, and when the power source 3b is turned off, the magnetic force generated by the coil 3a vanishes.

The fine particle analyzing apparatus 1 further includes a liquid channel structure 6 (6a, 6b) provided on the substrate 2. The liquid channel structure 6 includes a first supply channel 11 for supplying a liquid onto the substrate 2 and a first drain channel 12 for draining a liquid on the substrate 2. The liquid channel structure 6 is configured from a first member 6a and a second member 6b, and the second member 6b is provided outside the first member 6a. The material of the first member 6a and the second member 6b is, for example, a resin, such as polydimethylsiloxane (PDMS).

The first supply channel 11 includes a portion vertical to a surface of the substrate 2 and a portion parallel to the surface. The portion vertical to the surface of the substrate 2 of the first supply channel 11 is formed of the second member 6b, and the portion parallel to the surface of the substrate 2 of the first supply channel 11 is formed of the first member 6a. The same applies to the first drain channel 12. The first member 6a has an opening 7 and the specimen liquid is supplied onto the substrate 2 through the opening 7. The opening 7 functions as a liquid reservoir part of the specimen liquid.

Next, with reference to FIGS. 4 to 7, an operation of the fine particle analyzing apparatus 1 (analysis method of target particle) will be described.

First, as shown in FIG. 4, a specimen liquid (first liquid) 20 is supplied onto the substrate 2 through the opening 7. In the following description, the specimen liquid 20 is assumed to contain a target particle 8 and a foreign substance 9. The specimen liquid 20 may be supplied manually, or automatically by use of a device, such as a spotter, that operates in synchronization with the fine particle analyzing apparatus 1.

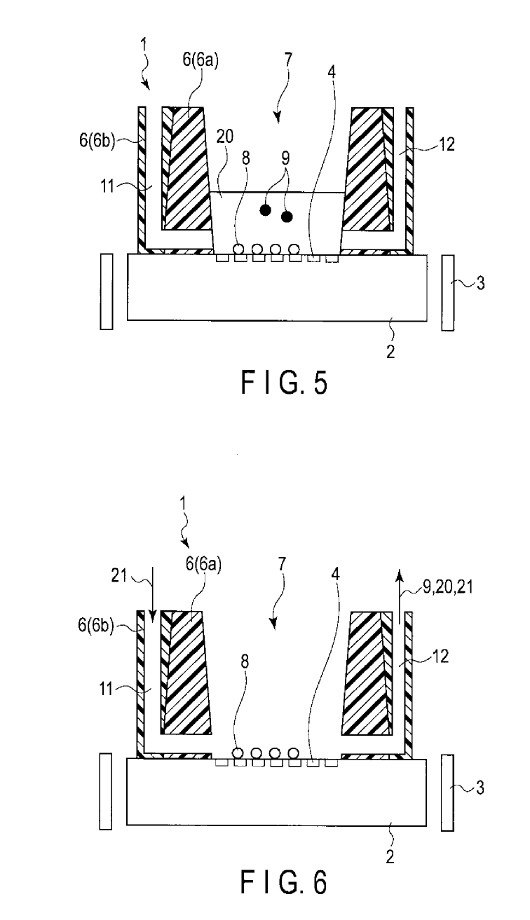

Next, the control device 5 controls the magnetic force generation device 3 to generate a magnetic force. Since the target particle 8 is labeled with the magnetic beads, the target particle 8 is drawn to the sensor surface by the magnetic force, as shown in FIG. 5. On the other hand, the foreign substances 9 which are not labeled with the magnetic bead are not drawn to the sensor surface. Consequently, the target particle 8 is selectively held on the sensor surface.

Since, as described above, the target particle 8 is drawn to the sensor surface by the magnetic force, the time until the target particle 8 in the specimen liquid 20 arrives at the sensor surface (settling time) is shortened. Consequently, the time required to complete measurement of the target particle in the specimen liquid 20 supplied onto the substrate 2 is shortened.

Next, the measurement device 4 measures an image of the specimen liquid 20 on the substrate. In the present embodiment, the measurement device 4 measures an image of the specimen liquid 20 on the sensor surface on the substrate. On this occasion, to be more effective, not an ambient light but an illumination light for obtaining a bright-field image may be irradiated into the specimen liquid 20 from a light source not illustrated. In the present application, the fine particle analyzing apparatus 1 encompasses a fine particle analyzing apparatus that does not include a light source.

Next, the control device 5, based on the image measured by the measurement device 4, determines whether or not the target particle 8 in the specimen liquid 20 is held on the sensor surface. In the present embodiment, if the target particle 8 has been measured, the control device 5 determines that the target particle 8 is held. In a case where the target particle 8 is determined to be held on the sensor surface, the control device 5 controls the magnetic force generation device 3 to keep generating the magnetic force.

After that, a cleaning is performed as shown in FIG. 6. That is, in a state where the target particle 8 is held on the sensor surface, a first cleaning liquid (second liquid) 21 is supplied from the first supply channel 11 onto the substrate 2, and the foreign substance 9 on the substrate 2, the specimen liquid 20, and the first cleaning liquid 21 are drained from the first drain channel 12. The first cleaning liquid 21 is appropriately selected according to the target particle 8a. For example, the first cleaning liquid 21 may include, but not limited to, pure water, physiological saline solution, phosphate buffer solution, serum, organic solvent, or surfactant added thereto. Such cleaning is possible, for example, by connecting a water pressure adjusting pump or the like to at least one of the first supply channel 11 and the first drain channel 12. These devices described above are controlled, for example, by the control device 5. Note that, in the present application, the fine particle analyzing apparatus 1 encompasses a fine particle analyzing apparatus that does not include a device for supplying and draining a liquid, such as a water pressure adjusting pump.

After completion of cleaning, the number of target particles or the like is measured and analyzed in a condition without the foreign substance 9.

Note that, when the target particle 8 is labeled with a fluorescent bead or a fluorescent staining in addition to the magnetic bead, and the specimen liquid 20 is irradiated with light having a predetermined wavelength, then the target particle 8 emits fluorescence having a predetermined wavelength, and an image formed by the fluorescence is measured with the measurement device 4 that further includes a filter not transmitting the irradiated light. The measurement of fluorescence facilitates identifying a type of the target particle. In addition, in a case where the target particle has a subcategory, the subcategory can be discriminated by the fluorescence. The light having the predetermined wavelength is irradiated from a light source (not shown) into the specimen liquid 20. In the present application, the fine particle analyzing apparatus 1 encompasses a fine particle analyzing apparatus that does not include a light source.

After that, the control device 5 controls the magnetic force generation device 3 to vanish the generated magnetic force.

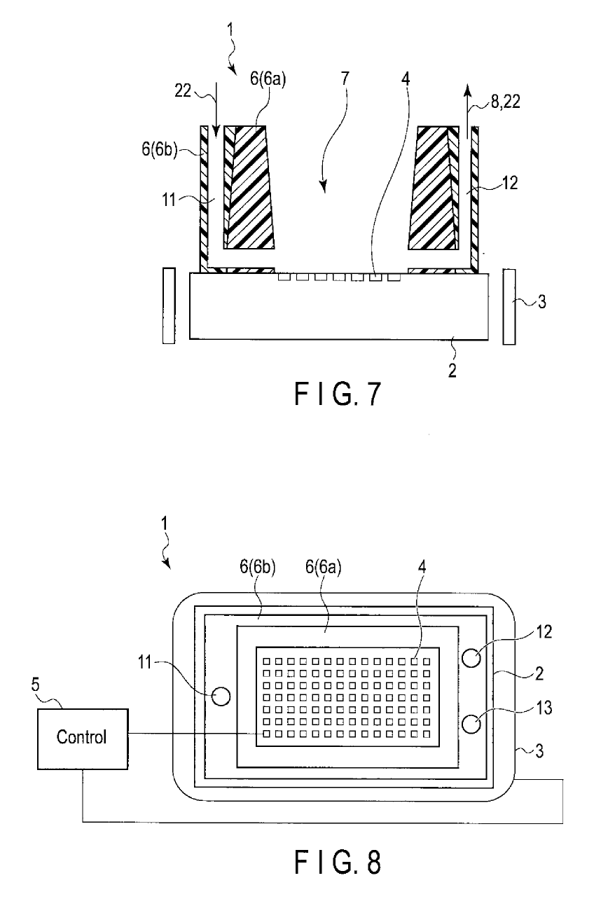

Next, as shown in FIG. 7, a second cleaning liquid (third liquid) 22 for draining the target particle 8 is supplied from the first supply channel 11 onto the substrate 2, and then the target particle 8 and the second cleaning liquid 22 (second cleaning liquid 22 containing the target particle 8) are drained from the first drain channel 12. The second cleaning liquid 22 is selected appropriately according to the target particle 8a like the first cleaning liquid 21.

Further, returning to the first step of supplying a specimen liquid, the same process may be repeated. Thus, a small amount of target particles contained in a large quantity of specimen liquid can be analyzed.

### Second Embodiment

FIG. 8 is a plane view showing a schematic configuration of a fine particle analyzing apparatus 1 according to the second embodiment.

The fine particle analyzing apparatus 1 of the present embodiment differs from the fine particle analyzing apparatus 1 of the first embodiment in a point that a liquid channel structure 6 further includes a second drain channel 13.

In the present embodiment, for example, in a state where a target particle is held on a sensor surface by a magnetic force, a first cleaning liquid is supplied from a first supply channel 11 onto a substrate 2, and a foreign substance, a specimen liquid, and a first cleaning liquid are drained from a first drain channel 12.

After that, in a state where a magnetic field has vanished, a second cleaning liquid is supplied from the first supply channel 11 onto the substrate 2, and the second cleaning liquid containing the target particle is drained from the second drain channel 13. Thus, mixing of the foreign substance into the second cleaning liquid containing the target particle can be prevented, and thereafter another further analysis, such as genomic analysis or protein analysis, can be performed on the target particle 8 in the drained cleaning liquid 22.

### Third Embodiment

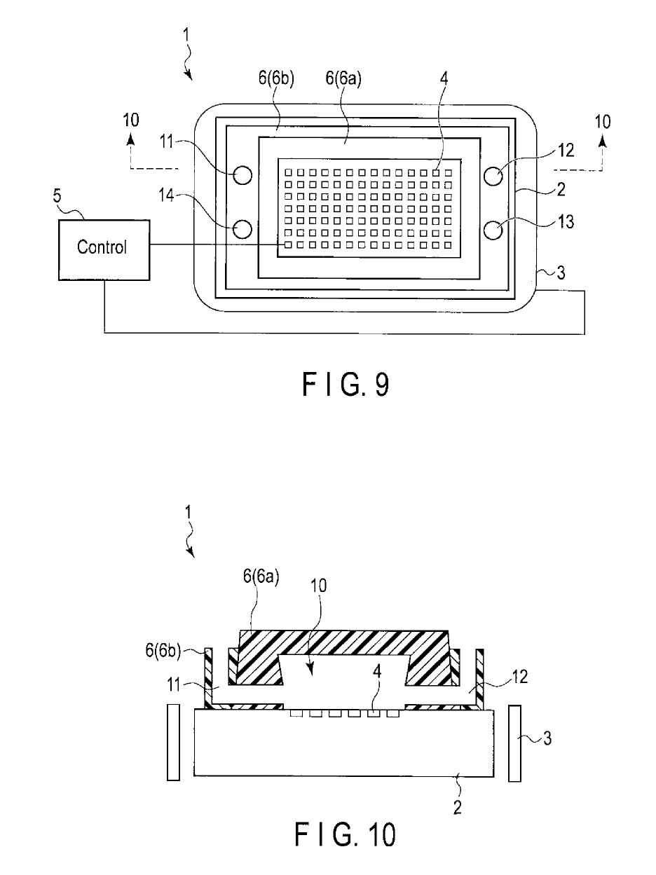

FIG. 9 is a plane view showing a schematic configuration of a fine particle analyzing apparatus 1 according to the third embodiment. FIG. 10 is a sectional view taken along arrows 10-10 of FIG. 9.

The fine particle analyzing apparatus 1 of the present embodiment differs from the fine particle analyzing apparatus 1 of the second embodiment in a first point that a liquid channel structure 6 forms a cavity region 10 (FIG. 10) together with a substrate 2. A specimen liquid is supplied into the cavity region 10.

The fine particle analyzing apparatus 1 of the present embodiment differs from the fine particle analyzing apparatus 1 of the second embodiment in a second point that the liquid channel structure 6 further includes a second supply channel 14 (FIG. 9). The second supply channel 14 corresponds to an opening 7 of the second embodiment, and the specimen liquid is supplied from the second supply channel 14 onto a sensor surface. A first supply channel 11, a first drain channel 12, a second drain channel 13, and the second supply channel 14 are connected to the cavity region 10. The cavity region 10 functions as a liquid reservoir part.

The first supply channel 11, the first drain channel 12, and the second drain channel 13 of the present embodiment correspond to the first supply channel 11, the first drain channel 12, and the second drain channel 13 of the second embodiment, respectively. Therefore, the target particle can be drained as in the second embodiment, and the same effect as that of the second embodiment can be obtained.

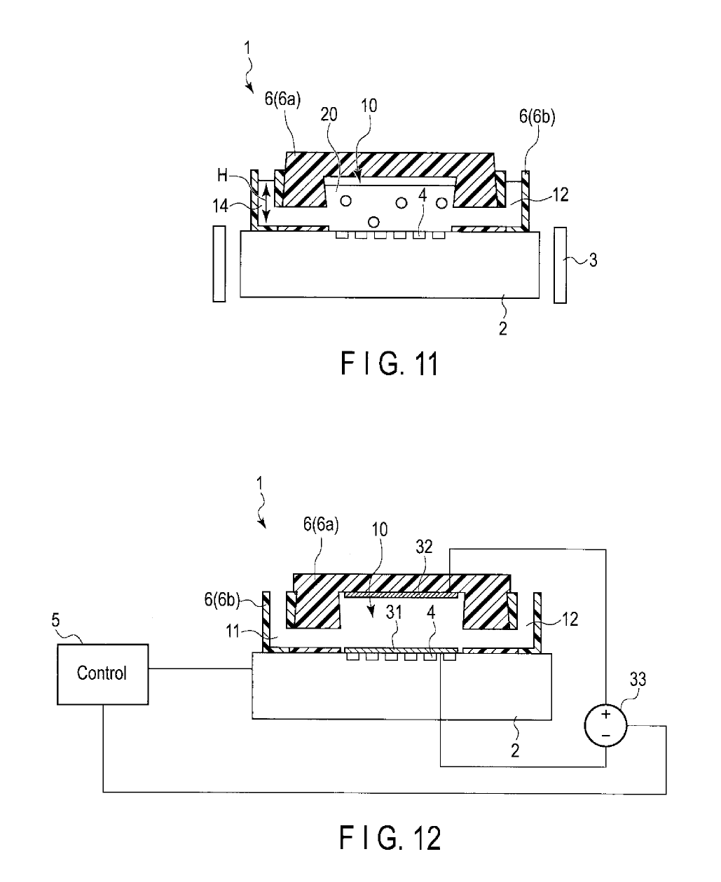

In addition, in the case of the present embodiment, for example, as shown in FIG. 11, the quantity of the specimen liquid 20 supplied into the cavity region 10 can be determined based on a height of the specimen liquid in the second supply channel 14. Thus, a fixed quantity of the specimen liquid 20 can be supplied into the cavity region 10, and as a result the precision of quantitativity is increased depending on an inspection item. Further, liquid scattering or the like can be prevented at the time of falling.

### Fourth Embodiment

FIG. 12 is a sectional view showing a schematic configuration of a fine particle analyzing apparatus 1 according to the fourth embodiment.

The fine particle analyzing apparatus 1 of the present embodiment differs from the fine particle analyzing apparatus 1 of the first to third embodiments in a point that an electrophoretic force generation device is used instead of the magnetic force generation device 3. The electrophoretic force generation device includes a first electrode 31 provided on a sensor surface in a cavity region 10, a second electrode 32 provided on an upper surface of the cavity region 10 and facing the first electrode 31, and a direct voltage source 33 for applying a direct voltage between the first electrode 31 and the second electrode 32. The first electrode 31 and the second electrode 32 are, for example, formed of a conductive transparent material, such as ITO (indium tin oxide) or conductive glass.

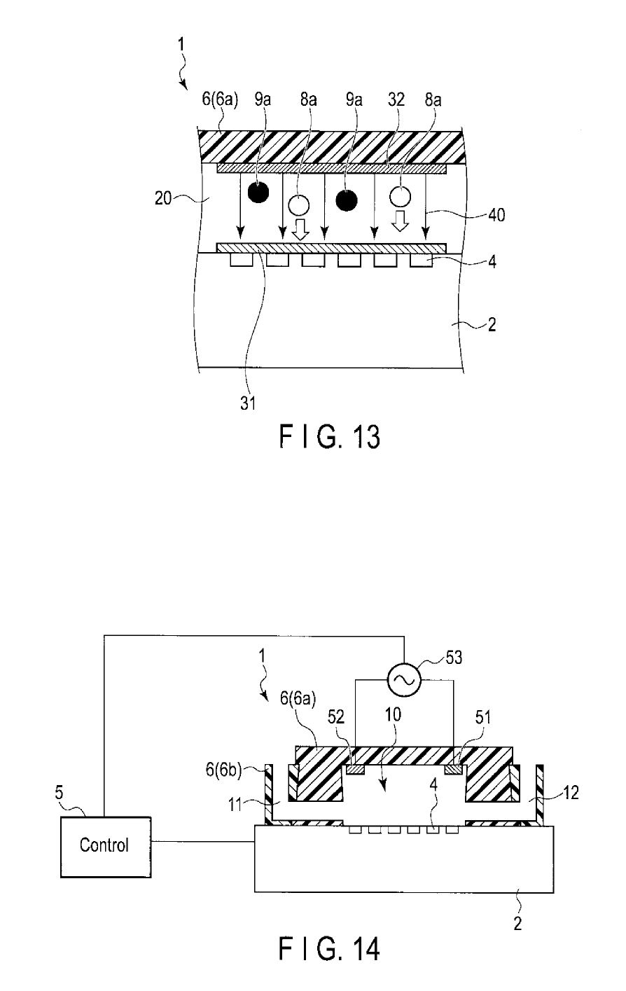

FIG. 13 is a diagram showing how a positively charged target particle 8a in a specimen liquid 20 is drawn onto the first electrode 31 (to a substrate 2 side) by an electrophoretic force. When the specimen liquid 20 is supplied onto the substrate 2, and a direct voltage is applied between the first electrode 31 and the second electrode 32 by the direct voltage source 33, then an electrostatic field 40 in a direction vertical to the sensor surface is generated in the specimen liquid 20, and the target particle 8a is drawn by the electrophoretic force to the first electrode 31 as indicated with block arrows. On the other hand, an uncharged foreign substance 9a is not drawn to the first electrode 31. As a result, the target particle 8a is selectively held on the sensor surface. In addition, as the target particle 8a is drawn to the sensor surface by the electrophoretic force, the time required until completion of measurement of the target particle 8a in the specimen liquid 20 supplied onto the substrate 2 is shortened.

Note that, although FIG. 12 shows an example of draining the positively charged target particle 8a, in a case of draining a negatively charged target particle 8a, the first electrode 31 and the second electrode 32 are connected to a plus electrode and a minus electrode of the direct voltage source 33, respectively.

### Fifth Embodiment

FIG. 14 is a sectional view showing a schematic configuration of a fine particle analyzing apparatus 1 according to the fifth embodiment.

The fine particle analyzing apparatus 1 of the present embodiment differs from the fine particle analyzing apparatus 1 of the first to third embodiments in a point that a dielectrophoretic force generation device is used instead of the magnetic force generation device 3. The dielectrophoretic force generation device includes a first electrode 51 provided on an upper surface in a cavity region 10, a second electrode 52 provided on an upper surface of the cavity region 10 and disposed apart from the first electrode 51, and an alternating voltage source 53 for applying an alternating voltage between the first electrode 51 and the second electrode 52. The first electrode 51 and the second electrode 52 are, for example, formed of a conductive transparent material, such as ITO or conductive glass.

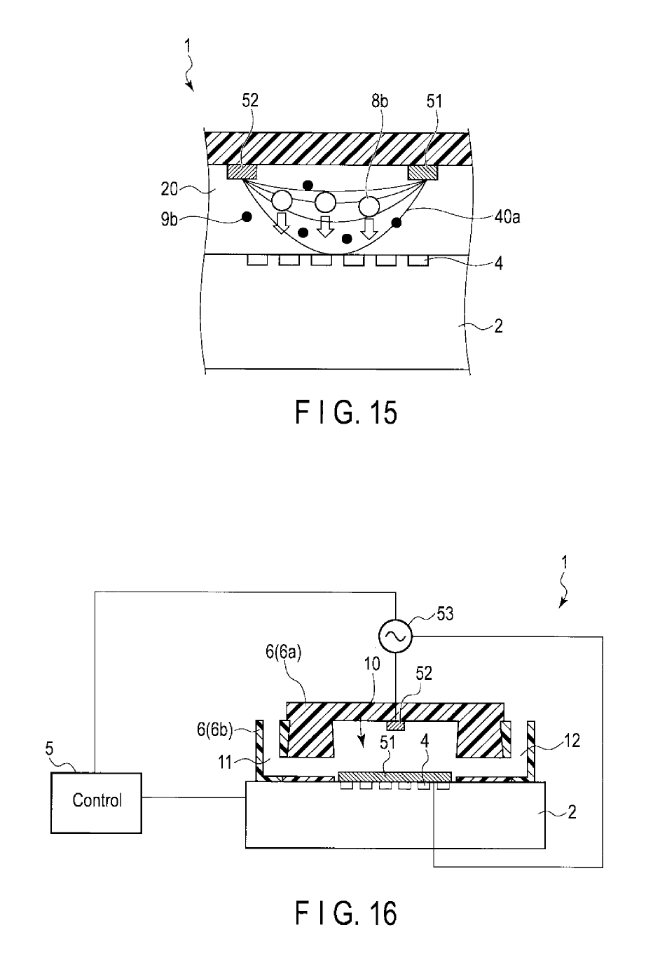

FIG. 15 is a diagram showing how a fine particle (target particle) 8b in a specimen liquid 20 is drawn onto the first electrode 51 (to a substrate 2 side) by a dielectrophoretic force. When the specimen liquid 20 is supplied onto the substrate 2, and an alternating voltage is applied between the first electrode 51 and the second electrode 52 by the alternating voltage source 53, then an alternating electric field 40a non-uniform in a direction vertical to the sensor surface is generated in the specimen liquid 20, and the target particle 8b is drawn by the dielectrophoretic force corresponding to its complex dielectric constant and a size to the sensor surface as indicated with block arrows. On the other hand, a foreign substance 9b having a complex dielectric constant different from that of the target particle is not drawn to the sensor surface. As a result, the target particle 8b is selectively held on the sensor surface. In addition, as the target particle 8b is drawn to the sensor surface by the dielectrophoretic force, the time required until completion of measurement of the target particle 8b in the specimen liquid 20 supplied onto the substrate 2 is shortened.

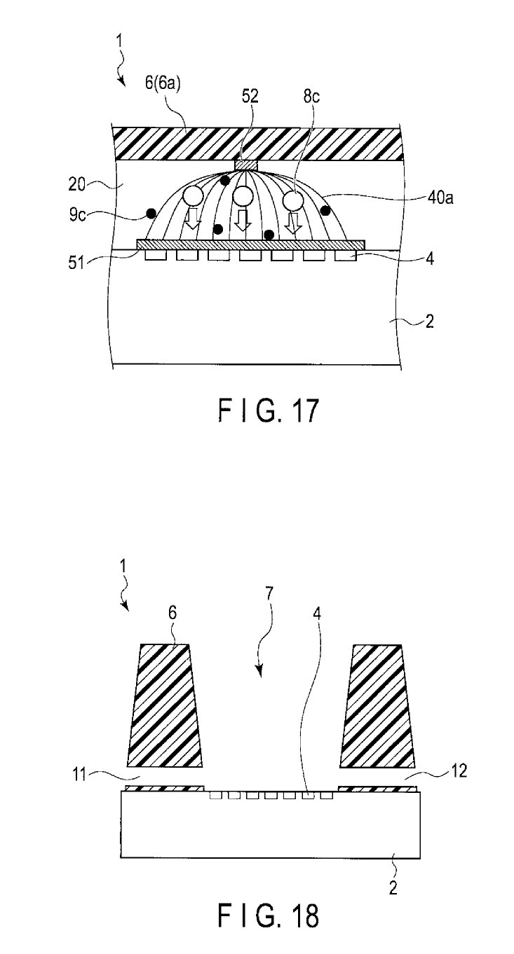

FIG. 16 is a sectional diagram showing a schematic configuration of a variation of the fine particle analyzing apparatus 1 according to the present embodiment. In the variation, a first electrode 51 is disposed on a sensor surface. The first electrode 51 covers the sensor surface. FIG. 17 is a diagram corresponding to FIG. 15 and is a diagram showing how a target particle 8c in a specimen liquid 20 is drawn to the first electrode 51 by a dielectrophoretic force. Although FIG. 17 shows negative dielectrophoresis by which the target particle 8c is drawn in a direction of low electric field density, if a vertical relation of the first electrode 51 and a second electrode 52 is reversed, the target particle 8c can be also drawn by the positive dielectrophoresis.

Note that, the target particle is not limited to a bio-based fine particle, such as a cell, and, for example, may be a floating fine particle, such as PM10 or PM2.5. In this case, instead of the specimen liquid, for example, a solvent in which the floating fine particle is dissolved is used.

Although in the above-described embodiments, the liquid channel structure including a portion vertical to the substrate 2 and a portion parallel to the substrate 2 is used for the supply channel and the drain channel, as shown in FIG. 18, a liquid channel structure 6 not including a portion vertical to the substrate 2 may be used.

Although in the above-described embodiments, the number of types of the target particle is one, two or more types of the target particle may be used. In this case, the numbers of the supply channels and drain channels may be appropriately changed according to the number of types of the target particle. For example, the number of the supply channels is the same as the number of types of the target particle, and the number of the drain channels is the same as the number of types of the target particle.

The target particle may be drawn to and held on the substrate side by use of an electromagnetic force other than an electrophoretic force and a dielectrophoretic force, for example, a force based on an electroosmotic flow. In addition, a labeling substance that labels a target particle according to an electromagnetic force to be used can be appropriately used. For example, usable is a labeling substance that includes at least one of a magnetic bead, a chargeable bead, and a bead having a predetermined complex dielectric constant and a predetermined size, which work according to the electromagnetic force to be used. As labeling principle, an antigen antibody, an aptamer, and the like are usable.

In addition, although in the above-described embodiments, the substrate 2 and the structure 6 are members separated from each other, a member formed by integrating the substrate 2 and the structure 6 may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An analyzing apparatus comprising:
a generation device configured to generate an electromagnetic force for drawing a particle in a first liquid that is to be supplied onto a substrate, wherein the electromagnetic force draws the particle to the substrate side;
a measurement device configured to measure an image of the first liquid on the substrate;
a control device configured to control the generation device; and
a liquid channel structure that includes a first supply channel for supplying a liquid onto the substrate and a first drain channel for draining the first liquid on the substrate.

2. The analyzing apparatus according to claim 1, wherein the control device controls the generation device to generate the electromagnetic force when the first liquid is supplied onto the substrate.

3. The analyzing apparatus according to claim 2, wherein the control device controls the generation device to keep generating the electromagnetic force when the control device determines that the particle is drawn to the substrate side based on the image measured by the measurement device.

4. The analyzing apparatus according to claim 3, wherein a second liquid is supplied from the first supply channel onto the substrate, and the first liquid and the second liquid on the substrate are drained from the first drain channel, in a state where the electromagnetic force is generated.

5. The analyzing apparatus according to claim 4, wherein the control device controls the generation device to vanish the electromagnetic force, after the first liquid and the second liquid are drained.

6. The analyzing apparatus according to claim 5, wherein a third liquid is supplied from the first supply channel onto the substrate, and the third liquid and the particle are drained from the first drain channel, after the electromagnetic force vanishes.

7. The analyzing apparatus according to claim 6, wherein the liquid channel structure further includes a second drain channel for draining a liquid on the substrate.

8. The analyzing apparatus according to claim 7, wherein a third liquid is supplied from the first supply channel onto the substrate, and the third liquid and the particle are drained from the second drain channel, after the electromagnetic force vanishes.

9. The analyzing apparatus according to claim 1, wherein the liquid channel structure further includes an opening that reaches the substrate, and the first liquid is supplied to the substrate through the opening.

10. The analyzing apparatus according to claim 1, wherein the liquid channel structure includes a plurality of supply channels for supplying liquid on the substrate and a plurality of drain channels for draining the liquid on the substrate.

11. The analyzing apparatus according to claim 1, wherein each of the channels includes a first portion vertical to a surface of the substrate and a second portion parallel to the surface.

12. The analyzing apparatus according to claim 1, wherein the electromagnetic force includes a magnetic force, an electrophoretic force, or a dielectrophoretic force.

13. The analyzing apparatus according to claim 12, wherein
the electromagnetic force is a magnetic force, and
the generation device includes a coil surrounding the substrate, and a power source for applying a current to the coil.

14. The analyzing apparatus according to claim 12, wherein
the electromagnetic force is an electrophoretic force, and
the generation device includes a first electrode, a second electrode that faces the first electrode, and a power source for applying a direct voltage between the first electrode and the second electrode.

15. The analyzing apparatus according to claim 12, wherein
the electromagnetic force is a dielectrophoretic force, and
the generation device includes a first electrode, a second electrode disposed apart from the first electrode, and a power source for applying an alternating voltage between the first electrode and the second electrode.

16. The analyzing apparatus according to claim 1, wherein a sensor surface of the measurement device is configured to be directly in contact with the first liquid supplied onto the substrate.

17. The analyzing apparatus according to claim 1, further comprising a light source configured to irradiate light into the first liquid.

18. The analyzing apparatus according to claim 1, wherein the particle is labeled with a labeling substance, or has chargeability.

19. The analyzing apparatus according to claim 18, wherein the labeling substance includes at least one of a magnetic bead, a chargeable bead, and a bead having a predetermined complex dielectric constant and a predetermined size.
